(19) United States
(12) Patent Application Publication
(10) Pub. No.: US 2024/0397595 A1
(43) Pub. Date: Nov. 28, 2024

(54) LOAD DRIVE CIRCUIT, LIGHT EMITTING DIODE DRIVER, AND DISPLAY DEVICE

(71) Applicant: LAPIS Technology Co., Ltd., Yokohama (JP)

(72) Inventor: Kenichi SHIIBAYASHI, Yokohama (JP)

(73) Assignee: LAPIS Technology Co., Ltd., Yokohama (JP)

(21) Appl. No.: 18/668,228

(22) Filed: May 19, 2024

(30) Foreign Application Priority Data
May 23, 2023 (JP) 2023-084319

(51) Int. Cl. H05B 45/48; G09G 3/34; G09G 3/36

(52) U.S. Cl. CPC H05B 45/48; G09G 3/342; G09G 3/3677; G09G 3/3688

(57) ABSTRACT

A load drive circuit includes: an external terminal which is connectable to a load; a first transistor having its drain connected to the external terminal, receiving a drive voltage at its gate, generating an output current corresponding to the drive voltage, and allowing the output current to flow between its drain and source; a second transistor leading the output current generated by the first transistor in an on state to a reference voltage line; and a control circuit receiving an instruction signal instructing driving or non-driving of the load and configured to control the second transistor to be in an on state when the instruction signal indicates the driving of the load or an off state and apply a control voltage having a predetermined voltage value higher than the reference voltage to the source of the first transistor when the instruction signal indicates the non-driving of the load.

### CROSS-REFERENCE TO RELATED APPLICATIONS

This application claims the priority benefit of Japan Application No. 2023-084319, filed on May 23, 2023. The entirety of the above-mentioned patent application is hereby incorporated by reference herein and made a part of this specification.

### BACKGROUND

### Technical Field

The disclosure relates to a load drive circuit which generates a drive current for driving a load, a light emitting diode (LED) driver which serves as the load drive circuit, and a display device which has a backlight driven by the LED driver.

### Description of Related Art

In recent years, liquid crystal display devices using light emitting diodes (LEDs) as backlight sources have been commercialized.

When using LEDs as a backlight source for large screen displays, it is necessary to supply a constant current to a plurality of LEDs connected in series. Therefore, as an LED driver that drives an LED backlight, there is proposed one in which feedback control of outputting a constant current is applied to a transistor (referred to as an output transistor) that generates a current flowing through an LED group (for example, see Patent Document 1 (Japanese Patent Application Laid-Open No. 2014-53139)).

Incidentally, the LED backlight consists of a large number of LEDs connected in series, and in order to cause all LEDs (loads) to emit light (drive), it is necessary to flow a current of several tens of milliamperes at maximum.

Therefore, as the output transistor of the LED driver, a high current output type with a large gate width is used.

However, since the high current output type transistor has a relatively large off-leakage current in an off state, there is a problem in that the off-leakage current flows into the LED and causes a slight emission of light even though the LED backlight is turned off (not driven).

Furthermore, the off-leakage current can be suppressed by using a transistor with a high threshold voltage as the output transistor, but since it is necessary to manufacture only the output transistor to increase the threshold voltage, a problem arises in that the manufacturing cost increases.

Therefore, the disclosure provides a load drive circuit, an LED driver, and a display device capable of suppressing manufacturing costs and suppressing a leakage current from flowing through a load when the load is not driven.

### SUMMARY

A load drive circuit according to the disclosure includes: an external terminal which is connectable to a load; a first transistor which has its drain connected to the external terminal, receives a drive voltage at its gate, generates an output current corresponding to the drive voltage, and allows the output current to flow between its drain and source; a second transistor which leads the output current generated by the first transistor in an on state to a reference voltage line to which a reference voltage is applied; and a control circuit which receives an instruction signal instructing driving or non-driving of the load and is configured to control the second transistor to be in an on state when the instruction signal indicates the driving of the load or to control the second transistor to be in an off state and apply a control voltage having a predetermined voltage value higher than the reference voltage to the source of the first transistor when the instruction signal indicates the non-driving of the load.

An LED driver according to the disclosure includes: an external terminal which is connectable to a light emitting diode; a first transistor which has its drain connected to the external terminal, receives a drive voltage at its gate, generates an output current corresponding to the drive voltage, and allows the output current to flow between its drain and source; a second transistor which leads the output current generated by the first transistor in an on state to a reference voltage line to which a reference voltage is applied; and a control circuit which receives an instruction signal instructing the light emitting diode to be turned on or off and is configured to control the second transistor to be in an on state when the instruction signal indicates the light on state or to control the second transistor to be in an off state and apply a control voltage having a predetermined voltage value higher than the reference voltage to the source of the first transistor when the instruction signal indicates the light off state.

A display device according to the disclosure includes: a liquid crystal display panel which includes a plurality of scan lines extending in a horizontal direction of a two-dimensional screen and a plurality of data lines extending in a vertical direction of a two-dimensional screen; a scan driver which sequentially applies horizontal scan pulses to each of the plurality of scan lines; a data driver which supplies a plurality of drive signals each having a voltage value corresponding to a luminance level of each pixel based on a video signal to the plurality of data lines; a backlight panel which is installed on a back surface of the liquid crystal display panel and includes first to r-th (r is an integer of 2 or more) light emitting diodes connected in series; and an LED driver which drives the first to r-th light emitting diodes, wherein the LED driver includes an external terminal which is connectable to a cathode of the last light emitting diode among the first to r-th light emitting diodes connected in series, a first transistor which has its drain connected to the external terminal, receives a drive voltage at its gate, generates an output current corresponding to the drive voltage, and allows the output current to flow between its drain and source, a second transistor which leads the output current generated by the first transistor in an on state to a reference voltage line to which a reference voltage is applied, and a control circuit which receives an instruction signal instructing the first to r-th light emitting diodes to be turned on or off and is configured to control the second transistor to be in an on state when the instruction signal indicates the light on state or to control the second transistor to be in an off state and apply a control voltage having a predetermined voltage value higher than the reference voltage to the source of the first transistor when the instruction signal indicates the light off state.

### BRIEF DESCRIPTION OF THE DRAWINGS

FIG. 1 is a block diagram showing a schematic configuration of a display device 100.

FIG. 2 is a circuit diagram showing an internal configuration of an LED driver 20.

FIG. 3A is a circuit diagram showing an example of an internal configuration of a threshold voltage control circuit 31.

FIG. 3B is a diagram showing an operation of the threshold voltage control circuit 31.

FIG. 4 is a circuit diagram showing an internal state of the LED driver 20 when light emitting diodes LE1 to LEr are turned on.

FIG. 5 is a circuit diagram showing an internal state of the LED driver 20 when the light emitting diodes LE1 to LEr are turned off.

FIG. 6 is a circuit diagram showing an internal configuration of an LED driver 20A.

FIG. 7 is a circuit diagram showing an internal state of the LED driver 20 when the light emitting diodes LE1 to LEr are turned on by the LED driver 20A.

FIG. 8 is a circuit diagram showing an internal state of the LED driver 20 when the light emitting diodes LE1 to LEr are turned off by the LED driver 20A.

### DESCRIPTION OF THE EMBODIMENTS

In the disclosure, the load is driven by the load drive circuit including the external terminal connectable to the load, the first and second transistors, and the control circuit below.

The first transistor has its drain connected to the external terminal, receives the drive voltage at its gate, generates an output current corresponding to the drive voltage, and allows the output current to flow between its drain and source. The second transistor leads the output current generated by the first transistor in an on state to the reference voltage line to which the reference voltage is applied. The control circuit receives the instruction signal instructing the driving or non-driving of the load, and controls the second transistor to be turned on when the instruction signal indicates the driving of the load. Accordingly, since the output current generated by the first transistor according to the drive voltage is led to the reference voltage line via the second transistor, the output current flows to the load, and the load is driven.

On the other hand, when the instruction signal indicates the non-driving of the load, the control circuit controls the second transistor to be in an off state and applies the control voltage having a predetermined voltage value higher than the reference voltage to the source of the first transistor. Accordingly, since a back bias is applied to the first transistor, the apparent threshold voltage of the first transistor increases, and the off-leakage current of the first transistor in an off state decreases.

Therefore, according to the disclosure, the apparent threshold voltage of the first transistor can be increased without using a transistor having a high threshold voltage as the first transistor, manufacturing costs can be suppressed, and leakage current flowing through the load when not driven can be suppressed.

Hereinafter, embodiments of the disclosure will be described with reference to the drawings.

### First Embodiment

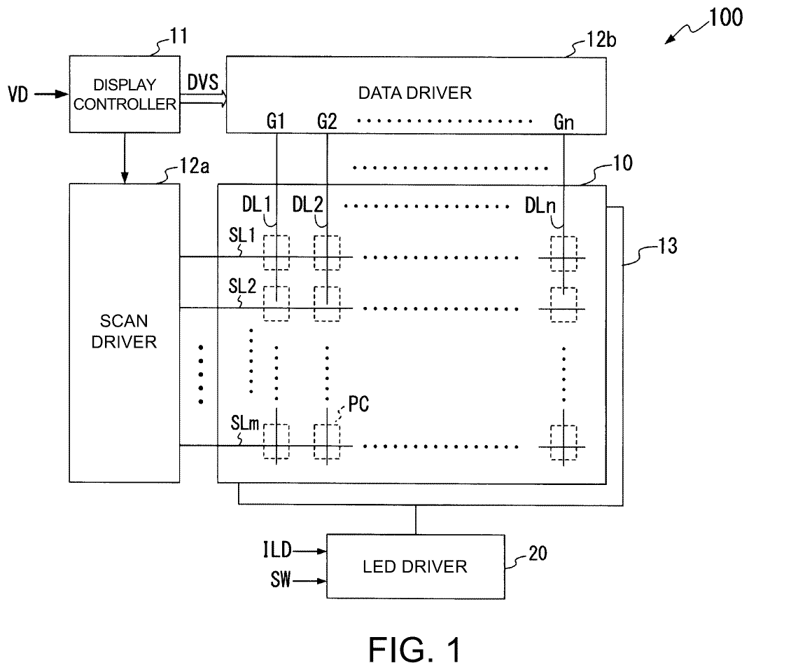

FIG. 1 is a block diagram showing a schematic configuration of a display device 100.

As shown in FIG. 1, the display device 100 includes a display panel 10, a display controller 11, a scan driver 12a, a data driver 12b, a backlight panel 13, and a light emitting diode (LED) driver 20 as a load drive circuit according to the disclosure.

The display panel 10 is composed of a liquid crystal display panel and includes scan lines SL1 to SLm (m is an integer of 2 or more) extending in a horizontal direction of a two-dimensional screen and data lines DL1 to DLn (n is an integer of 2 or more) extending in a vertical direction of a two-dimensional screen. A display cell PC serving as a pixel is formed at each intersection of the scan line and the data line.

The display controller 11 receives a video signal VD and supplies a scan timing signal indicating the timing of applying a horizontal scan pulse to each scan line according to the video signal VD to the scan driver 12a. Furthermore, the display controller 11 generates a video digital signal DVS including various control signals and a series of display data pieces indicating the luminance level of each pixel based on the video signal VD, and supplies the video digital signal to the data driver 12b.

The scan driver 12a sequentially applies a horizontal scan pulse synchronized with the scan timing signal supplied from the display controller 11 to each of the scan lines SL1 to SLm of the display panel 10.

The data driver 12b first takes in a series of display data pieces corresponding to each pixel included in the video digital signal DVS by the number of data lines, that is, n pieces in response to the video digital signal DVS. Next, the data driver 12b converts each of the n taken display data pieces into a drive signal having an analog voltage value corresponding to the luminance level indicated by the display data piece and supplies the obtained n drive signals to the data lines DL1 to DLn of the display panel 10 as drive signals G1 to Gn.

The backlight panel 13 includes a light guide plate installed on the back surface of the display panel 10 and a plurality of light emitting diodes (LEDs) as light sources. The backlight panel 13 irradiates light generated by each of the plurality of light emitting diodes toward an image display area of the display panel 10 via the light guide plate described above.

The LED driver 20 drives a plurality of light emitting diodes included in the backlight panel 13.

Specifically, the LED driver 20 receives an illuminance signal ILD, generates an output current that allows the light emitting diodes to emit light with the illuminance indicated by the illuminance signal ILD, and allows the output current to flow in the plurality of light emitting diodes included in the backlight panel 13. Further, the LED driver 20 receives an on/off switch signal SW and generates the output current when the on/off switch signal SW indicates “on” or stops generating the output current when the light on/off switch signal SW indicates “off”.

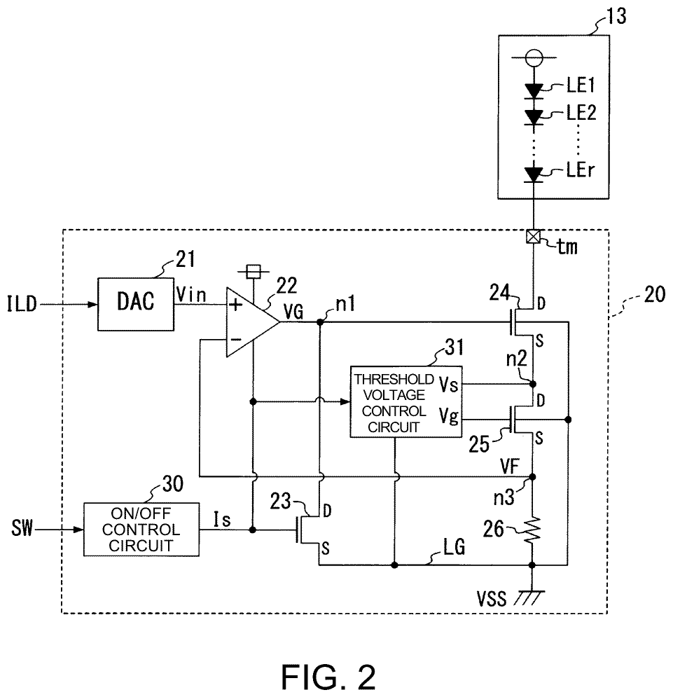

FIG. 2 is a circuit diagram showing the internal configuration of the LED driver 20 and the connection form of the plurality of light emitting diodes included in the backlight panel 13.

As shown in FIG. 2, the backlight panel 13 includes light emitting diodes LE1 to LEr (r is an integer of 2 or more) connected in series. Furthermore, a power supply voltage is applied to the anode end of the first stage light emitting diode LE1 among the light emitting diodes LE1 to LEr, and the cathode end of the last stage light emitting diode LEr is connected to the external terminal tm of the LED driver 20.

The LED driver 20 includes a digital-to-analog converter (DAC) 21, a differential amplifier 22, N-channel transistors 23 to 25, a resistor 26, an on/off control circuit 30, and a threshold voltage control circuit 31.

The digital-to-analog converter 21 receives the illuminance signal ILD indicating the illuminance as a digital value when allowing the light emitting diodes LE1 to LEr to emit light. The digital-to-analog converter 21 converts the illuminance indicated by the illuminance signal ILD into a voltage corresponding to the current value of the output current required to allow the light emitting diodes LE1 to LEr to emit light at that illuminance. The digital-to-analog converter 21 supplies such a converted voltage signal Vin which specifies the current value of the output current of the light emitting diodes LE1 to LEr by a voltage value to the non-inverting input terminal of the differential amplifier 22.

The on/off control circuit 30 receives the on/off switch signal SW that instructs the light emitting diodes LE1 to LEr to be turned on or off and generates an on/off instruction signal Is having a predetermined first voltage V1 that instructs “off” when the on/off switch signal SW indicates “off”. On the other hand, the on/off control circuit 30 generates an on/off instruction signal Is having a reference voltage VSS (for example, 0 volt) that instructs “on” when the on/off switch signal SW indicates “on”.

The on/off control circuit 30 supplies the on/off instruction signal Is generated in this way to the gate of a transistor 23, the differential amplifier 22, and the threshold voltage control circuit 31.

The differential amplifier 22 receives the power supply voltage at its power supply terminal, and receives the on/off instruction signal Is at its ground terminal. The differential amplifier 22 performs the following operation when the voltage value of the on/off instruction signal Is has the reference voltage VSS. That is, the differential amplifier 22 receives a feedback voltage VF (described later) at its inverting input terminal, and generates a drive voltage VG having a voltage value corresponding to the difference between the feedback voltage VF and the voltage signal Vin. The differential amplifier 22 supplies the generated drive voltage VG from its output terminal via a node n1 to the drain of the transistor 23 and the gate of the transistor 24 as an output transistor. Furthermore, when the voltage value of the on/off instruction signal Is has the above-described first voltage V1, the differential amplifier 22 is in a non-operating state, and its output terminal is in a high impedance (HiZ) state.

Te drain of the transistor 23 is connected to the node n1 and its source is connected to a reference voltage line LG. The reference voltage VSS is applied to the reference voltage line LG. The transistor 23 is turned off when the on/off instruction signal Is received at its gate has the reference voltage VSS that instructs “on”. On the other hand, when the on/off instruction signal Is has the first voltage V1 indicating “off”, the transistor is turned on and applies the reference voltage VSS to the node n1.

The drain of the transistor 24 is connected to the cathode of the light emitting diode LEr included in the backlight panel 13 via the external terminal tm. The source of the transistor 24 is connected to the drain of the transistor 25 via a node n2, and the back gate is connected to the reference voltage line LG. The transistor 24 is turned on when the difference between the drive voltage VG received at the gate and the voltage at its source is higher than its threshold voltage Vth, generates an output current having a current value corresponding to the drive voltage VG, and allows the current to flow between its drain and source.

The threshold voltage control circuit 31 receives the on/off instruction signal Is and generates control voltages Vs and Vg each having a voltage value according to the on/off instruction signal Is.

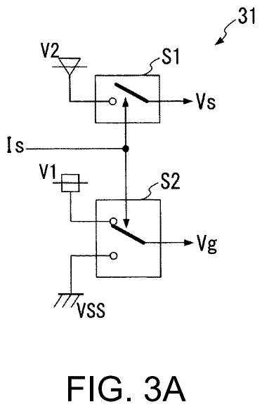

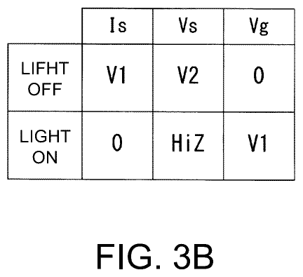

FIG. 3A is a circuit diagram showing an example of an internal configuration of the threshold voltage control circuit 31 and FIG. 3B is a diagram showing an operation of the threshold voltage control circuit 31.

As shown in FIG. 3A, the threshold voltage control circuit 31 includes a switch element S1 and a selector S2.

When the on/off instruction signal Is has the first voltage V1 indicating “off”, the switch element S1 is turned on and outputs a control voltage Vs having a predetermined second voltage V2 higher than the reference voltage VSS (0 volt) and lower than the first voltage V1. On the other hand, when the on/off instruction signal Is has the reference voltage VSS indicating “on”, the switch element S1 is turned off and outputs the control voltage Vs in a high impedance (HiZ) state.

The selector S2 receives the first voltage V1 and the reference voltage VSS (0 volt). When the on/off instruction signal Is has the first voltage V1 indicating “off”, the selector selects the reference voltage VSS from the first voltage V1 and the reference voltage VSS and outputs the control voltage Vg having the reference voltage VSS. On the other hand, when the on/off instruction signal Is has the reference voltage VSS indicating “on”, the selector S2 selects the first voltage V1 from the first voltage V1 and the reference voltage VSS and outputs the control voltage Vg having the first voltage V1.

With such a configuration, when the on/off instruction signal Is has the first voltage V1 indicating “off” as shown in FIG. 3B, the threshold voltage control circuit 31 outputs the control voltage Vs having the second voltage V2 and the control voltage Vg having the reference voltage VSS. On the other hand, when the on/off instruction signal Is has the reference voltage VSS indicating “on”, the threshold voltage control circuit 31 outputs the control voltage Vs in a high impedance (HiZ) state and the control voltage Vg having the first voltage V1 as shown in FIG. 3B.

The threshold voltage control circuit 31 applies the control voltage Vs output as described above to the node n2 and supplies the control voltage Vg to the gate of the transistor 25.

The transistor 25 has its source connected to one end of the resistor R26 via a node n3 and its back gate connected to the reference voltage line LG. Furthermore, the other end of the resistor 26 is connected to the reference voltage line LG. Here, the resistor 26 converts the voltage generated at one end of the resistor 26 due to the current flowing therethrough into the feedback voltage VF which is supplied to the inverting input terminal of the differential amplifier 22.

The transistor 25 is turned on when the voltage value of the difference between the control voltage Vg received at the gate and the voltage at its source is higher than its threshold voltage Vth, lads the output current generated by the transistor 24 to the reference voltage line LG via the resistor 26.

Hereinafter, the internal operation of the LED driver 20 will be described separately when the light emitting diodes LE1 to LEr are turned on and when they are turned off. Further, in the following description, an example of the internal operation of the LED driver 20 will be described on the assumption that the voltage values of the first voltage V1 and the second voltage V2 are V1=18 volt [V] and V2=1 volt [V].

### [Light on State]

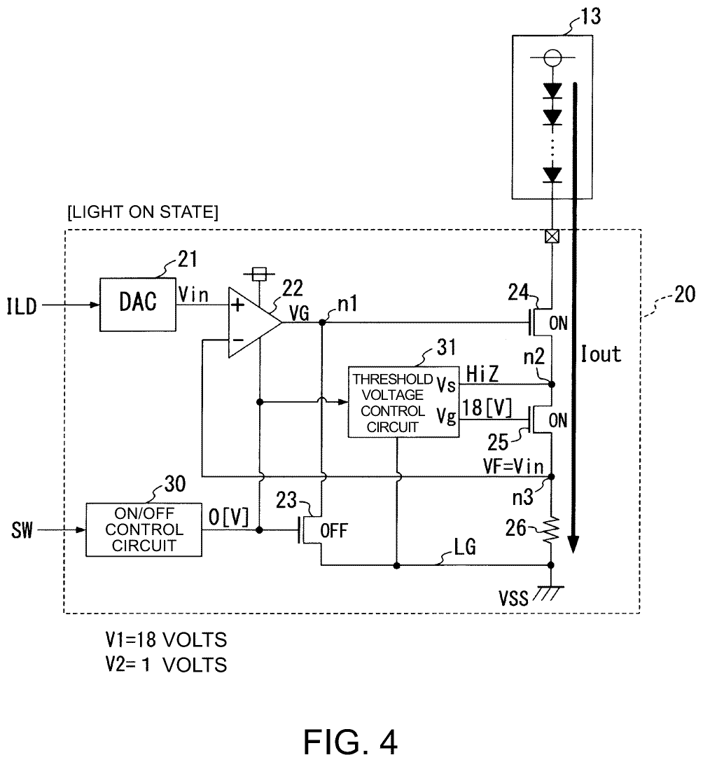

FIG. 4 is a circuit diagram showing an internal state of the LED driver 20 when the light emitting diodes LE1 to LEr are turned on.

First, the on/off control circuit 30 supplies the on/off instruction signal Is of 0 volt to the gate of the transistor 23 and the threshold voltage control circuit 31 in response to the on/off switch signal SW indicating “on”. Accordingly, the transistor 23 is turned off, and the differential amplifier 22 supplies the drive voltage VG having a voltage value corresponding to the difference between the voltage signal Vin and the feedback voltage VF to the gate of the transistor 24. Therefore, the transistor 24 is turned on and generates an output current Iout having a current value corresponding to the drive voltage VG.

At this time, the threshold voltage control circuit 31 supplies the control voltage Vs in a high impedance (HiZ) state to the node n2, and supplies the control voltage Vg of 18 volts to the gate of the transistor 25 in response to the on/off instruction signal Is of 0 volt. Therefore, the transistor 25 is turned on, and the output current Iout generated by the transistor 24 is led out to the reference voltage line LG via the transistor 25 and the resistor 26. Accordingly, the output current Iout flows through the light emitting diodes LE1 to LEr included in the backlight panel 13, and the light emitting diodes LE1 to LEr emit light at the illuminance indicated by the illuminance signal ILD.

### [Light Off State]

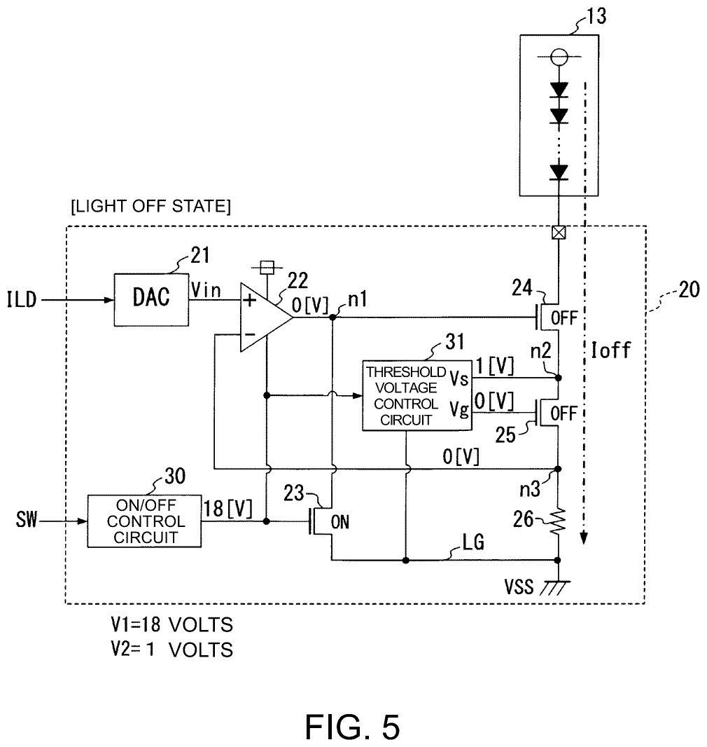

FIG. 5 is a circuit diagram showing an internal state of the LED driver 20 when the light emitting diodes LE1 to LEr are turned off.

First, the on/off control circuit 30 supplies the on/off instruction signal Is of 18 volts to the gate of the transistor 23, the ground terminal of the differential amplifier 22, and the threshold voltage control circuit 31 in response to the on/off switch signal SW indicating “off”. Accordingly, since the differential amplifier 22 stops operating and its output becomes a high impedance state to turn on the transistor 23, the voltage value of the drive voltage VG is fixed to the reference voltage VSS (0 volt) regardless of the voltage signal Vin and thus the transistor 24 is turned off.

At this time, the threshold voltage control circuit 31 applies the control voltage Vs of 1 volt to the node n2, that is, the source of the transistor 24 and supplies the control voltage Vg of 0 volt to the gate of the transistor 25 in response to the on/off instruction signal Is of 18 volts. Accordingly, the transistor 25 as well as the transistor 24 are turned off, so that the output current Iout does not flow through the light emitting diodes LE1 to LEr and the light is turned off.

However, an off-leakage current Ioff from the transistor 24 in an off state may flow through the current path formed by the light emitting diodes LE1 to LEr, the transistors 24 and 25, and the resistor 26.

Therefore, in the LED driver 20, when the light emitting diodes LE1 to LEr are turned off, the threshold voltage control circuit 31 applies the control voltage Vs of 1 volt to the source of the transistor 24 to apply a back bias to the transistor 24. Accordingly, the apparent threshold voltage Vth of the transistor 24 increases, and the off-leakage current Ioff of the transistor 24 decreases.

Therefore, according to the LED driver 20, the apparent threshold voltage of the transistor 24 can be increased without using a transistor whose threshold voltage is higher than other transistors. Therefore, according to the LED driver 20, it is possible to reduce manufacturing costs and suppress leakage current flowing into the light emitting diodes LE1 to LEr when the light is turned off.

### Second Embodiment

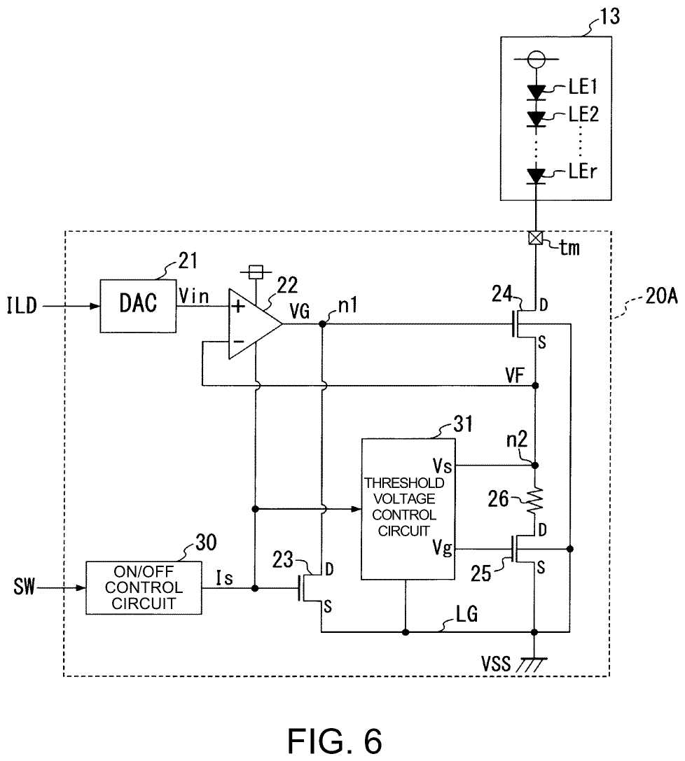

FIG. 6 is a circuit diagram showing an internal configuration of an LED driver 20A as a modified example of the LED driver 20 shown in FIG. 2.

Furthermore, similarly to the LED driver 20 shown in FIG. 2, the LED driver 20A drives the light emitting diodes LE1 to LEr of the backlight panel 13 connected to the external terminal tm. Further, similarly to the LED driver 20 shown in FIG. 2, the LED driver 20A includes the digital-to-analog converter (DAC) 21, the differential amplifier 22, the N-channel transistors 23 to 25, the resistor 26, the on/off control circuit 30, and the threshold voltage control circuit 31.

However, in the LED driver 20A, the resistor 26 is connected between the source of the transistor 24 and the drain of the transistor 25 instead of being connected between the source of the transistor 25 and the reference voltage line LG as shown in FIG. 2. Furthermore, the source of the transistor 25 is connected to the reference voltage line LG.

At this time, it is similar to those shown in FIG. 2 in that the voltage generated at the node n2, that is, one end of the resistor 26 is supplied to the inverting input terminal of the differential amplifier 22 as the feedback voltage VF and that the control voltage Vs output from the threshold voltage control circuit 31 is applied to the source of the transistor 24 and the control voltage Vg is applied to the gate of the transistor 25.

Hereinafter, the internal operation of the LED driver 20A will be described separately when the light emitting diodes LE1 to LEr are turned on and when they are turned off. Furthermore, in the following description, an example of the internal operation of the LED driver 20A will be described on the assumption that the voltage values of the first voltage V1 and the second voltage V2 are V1=18 volt [V] and V2=1 volt [V].

### [Light on State]

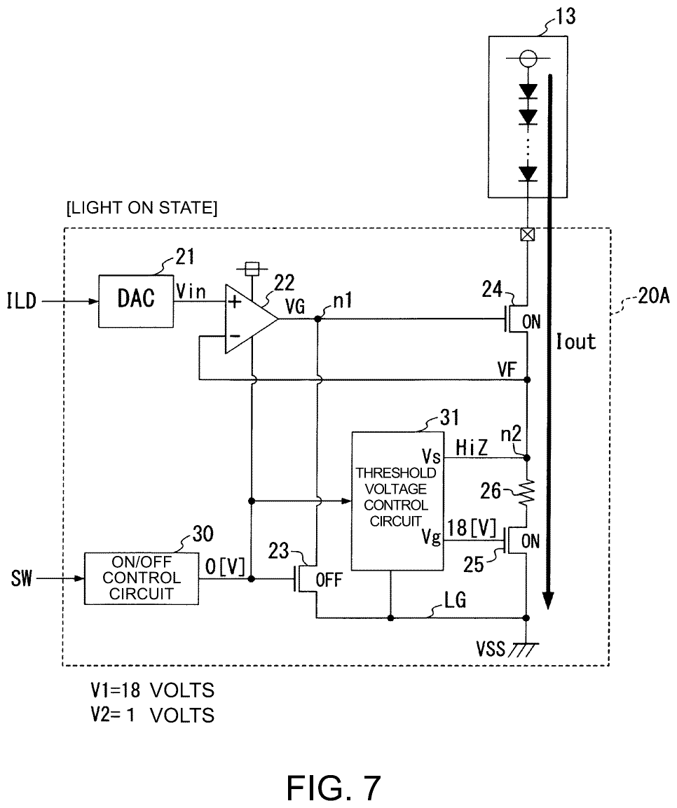

FIG. 7 is a circuit diagram showing an internal state of the LED driver 20A when the light emitting diodes LE1 to LEr are turned on.

First, the on/off control circuit 30 supplies the on/off instruction signal Is of 0 volt to the gate of the transistor 23 and the threshold voltage control circuit 31 in response to the on/off switch signal SW indicating “on”. Accordingly, the transistor 23 is turned off and the differential amplifier 22 supplies the drive voltage VG having a voltage value corresponding to the difference between the voltage signal Vin and the feedback voltage VF to the gate of the transistor 24. Therefore, the transistor 24 is turned on and generates the output current Iout having a current value corresponding to the drive voltage VG.

At this time, the threshold voltage control circuit 31 supplies the control voltage Vs in a high impedance (HiZ) state to the node n2 and supplies the control voltage Vg of 18 volt to the gate of the transistor 25 in response to the on/off instruction signal Is of 0 volt. Therefore, the transistor 25 is turned on and the output current Iout generated by the transistor 24 is led out to the reference voltage line LG via the transistor 25. Accordingly, the output current Iout flows through the light emitting diodes LE1 to LEr included in the backlight panel 13 and the light emitting diodes LE1 to LEr emits light at the illuminance indicated by the illuminance signal ILD.

### [Light Off State]

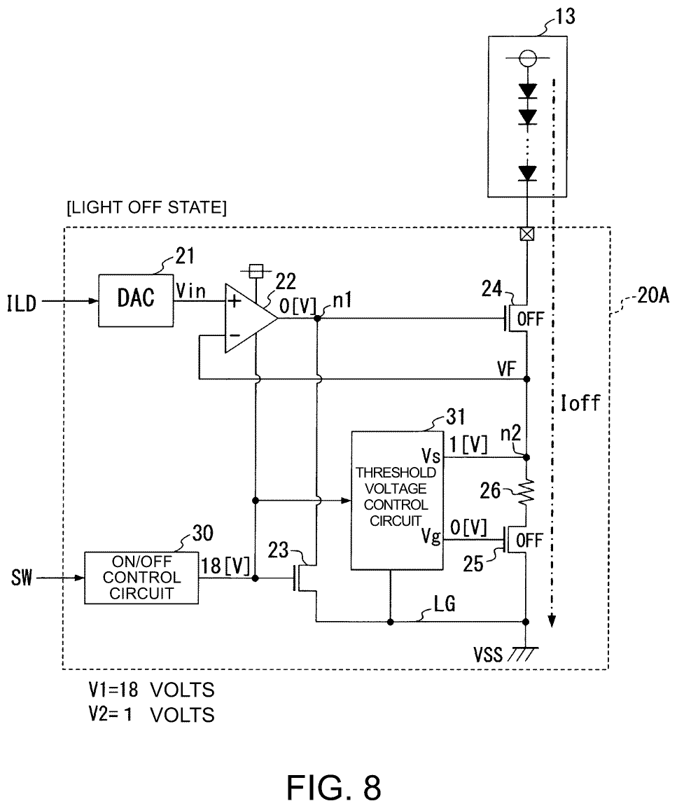

FIG. 8 is a circuit diagram showing an internal state of the LED driver 20A when the light emitting diodes LE1 to LEr are turned off.

First, the on/off control circuit 30 supplies the on/off instruction signal Is of 18 volts instructing “off” to the gate of the transistor 23, the ground terminal of the differential amplifier 22, and the threshold voltage control circuit 31 in response to the on/off switch signal SW indicating “off”. Accordingly, since the output of the differential amplifier 22 is in a high impedance state and the transistor 23 is turned on, the voltage value of the drive voltage VG output from the differential amplifier 22 is fixed to the reference voltage VSS (0 volt) regardless of the voltage signal Vin and thus the transistor 24 is turned off.

At this time, the threshold voltage control circuit 31 applies the control voltage Vs of 1 volt to the source of the transistor 24 and supplies the control voltage Vg of 0 volt to the gate of the transistor 25 in response to the on/off instruction signal Is of 18 volts.

Accordingly, since the transistor 25 is turned off together with the transistor 24, the output current Iout does not flow through the light emitting diodes LE1 to LEr, and the light is turned off.

However, an off-leakage current Ioff from the transistor 24 in an off state may flow through the current path formed by the light emitting diodes LE1 to LEr, the transistor 24, the resistor 26, and the transistor 25.

Therefore, in the LED driver 20A, when the light emitting diodes LE1 to LEr are turned off, the threshold voltage control circuit 31 applies the control voltage Vs of 1 volt to the source of the transistor 24 to apply a back bias to the transistor 24. Accordingly, the apparent threshold voltage Vth of the transistor 24 increases, and the off-leakage current Ioff of the transistor 24 decreases.

Therefore, according to the LED driver 20A, the apparent threshold voltage of the transistor 24 can be increased without using the transistor 24 that has a higher threshold voltage than other transistors the transistor 24. Therefore, according to the LED driver 20, it is possible to reduce manufacturing costs and suppress leakage current flowing into the light emitting diodes LE1 to LEr when the light is turned off.

Furthermore, in the LED driver 20A, the output current Iout flowing when the feedback voltage VF is equal to the voltage signal Vin is expressed by Iout=Vin/(Rout+Ron) when Rout indicates the resistance value of the resistor 26 and Ron indicates the on-resistance value of the transistor 25, and in the LED driver 20 shown in FIG. 2, the output current Iout is expressed by Iout=Vin/Rout.

Further, in the case of the LED driver 20, since the source voltage of the transistor 25 when the light emitting diodes LE1 to LEr are turned on is the voltage signal Vin and the gate voltage is 18 volts as shown in FIG. 4, the gate threshold voltage Vgs is expressed by Vgs=18 volts-Vin.

On the other hand, in the case of the LED driver 20A, since the source voltage of the transistor 25 when the light emitting diodes LE1 to LEr are turned on is 0 volt (VSS) and the gate voltage is 18 volts as shown in FIG. 7, the gate threshold voltage Vgs is expressed by Vgs=18 volts.

Therefore, when the configuration of the LED driver 20A is adopted, the gate threshold voltage Vgs of the transistor 25 is increased by the voltage signal Vin compared to the case where the configuration of the LED driver 20 is adopted. Therefore, the gate width of the transistor 25 can be reduced by that amount, and the circuit area can be reduced.

Furthermore, in the above-described embodiments, although the transistors 24 and 25 are N-channel type metal oxide semiconductor (MOS) transistors, these transistors 24 and 25 may be P-channel type MOS transistors.

Further, in the above-described embodiments, the LED driver 20 (20A) driving the light emitting diodes LE1 to LEr (load) has been exemplified as the load drive circuit and the configuration and the operation when turning on the light (when driven) and when turning off the light (when not driven) have been described. However, the load to be driven is not limited to the light emitting diodes.

In short, the load drive circuit according to the disclosure may be any circuit as long as the load drive circuit includes the first and second transistors and the control circuit below together with the external terminal (tm) configured to be connectable to the load.

The first transistor (24) has its drain connected to the above-described external terminal, receives the drive voltage (VG) at its gate, generates an output current (Iout) corresponding to this drive voltage, and allows the output current to flow between its drain and source.

The second transistor (25) leads the output current generated by the first transistor in an on state to the reference voltage line (LG) to which the reference voltage (VSS) is applied.

The control circuit (31) receives an instruction signal (Is) instructing driving or non-driving of the load, and controls the second transistor to be in an on state when this instruction signal indicates driving of the load. On the other hand, when the instruction signal indicates non-driving of the load, the control circuit (31) controls the second transistor to be in an off state and also applies the control voltage (Vs) having a predetermined voltage value (V2) higher than the reference voltage to the source of the first transistor.

With such a configuration, when receiving the instruction signal instructing driving of the load, the output current generated by the first transistor according to the drive voltage is led to the reference voltage line via the second transistor. Accordingly, an output current (Iout) flows through the load (for example, LE1 to LEr), and the load is driven.

On the other hand, when receiving the instruction signal instructing non-driving of the load, the second transistor is turned off and a control voltage higher than the reference voltage is applied to the source of the first transistor. Accordingly, since a back bias is applied to the first transistor, the apparent threshold voltage of the first transistor increases, and the off-leakage current of the first transistor in an off state decreases.

Therefore, according to the load drive circuit of the disclosure, the apparent threshold voltage of the first transistor can be increased without using a transistor having a high threshold voltage as the first transistor, manufacturing costs can be suppressed, and leakage current flowing through the load when not driven can be suppressed.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A load drive circuit comprising:
an external terminal which is connectable to a load;
a first transistor which has its drain connected to the external terminal, receives a drive voltage at its gate, generates an output current corresponding to the drive voltage, and allows the output current to flow between its drain and source;
a second transistor which leads the output current generated by the first transistor in an on state to a reference voltage line to which a reference voltage is applied; and
a control circuit which receives an instruction signal instructing driving or non-driving of the load and is configured to control the second transistor to be in an on state when the instruction signal indicates the driving of the load or to control the second transistor to be in an off state and apply a control voltage having a predetermined voltage value higher than the reference voltage to the source of the first transistor when the instruction signal indicates the non-driving of the load.

2. The load drive circuit according to claim 1,
wherein a back gate of each of the first transistor and the second transistor is connected to the reference voltage line.

3. The load drive circuit according to claim 1, further comprising:
a resistor which is included in a current path of the output current including the first transistor and the second transistor and converts the output current into a voltage;
a differential amplifier which receives a voltage signal specifying a current value of the output current by a voltage value and outputs a difference between the voltage signal and the voltage converted by the resistor to the gate of the first transistor as the drive voltage via a first node; and
a third transistor which receives the instruction signal at a gate and is turned on to apply the reference voltage to the first node when the instruction signal indicates the non-driving of the load.

4. The load drive circuit according to claim 2, further comprising:
a resistor which is included in a current path of the output current including the first transistor and the second transistor and converts the output current into a voltage;
a differential amplifier which receives a voltage signal specifying a current value of the output current by a voltage value and outputs a difference between the voltage signal and the voltage converted by the resistor to the gate of the first transistor as the drive voltage via a first node; and
a third transistor which receives the instruction signal at a gate and is turned on to apply the reference voltage to the first node when the instruction signal indicates the non-driving of the load.

5. The load drive circuit according to claim 3, wherein
a drain of the second transistor is connected to a source of the first transistor, and
one end of the resistor is connected to a source of the second transistor and the other end of the resistor is connected to the reference voltage line.

6. The load drive circuit according to claim 3, wherein
a source of the second transistor is connected to the reference voltage line, and
one end of the resistor is connected to a source of the first transistor and the other end of the resistor is connected to a drain of the second transistor.

7. A light emitting diode driver comprising:
an external terminal which is connectable to a light emitting diode;
a first transistor which has its drain connected to the external terminal, receives a drive voltage at its gate, generates an output current corresponding to the drive voltage, and allows the output current to flow between its drain and source;
a second transistor which leads the output current generated by the first transistor in an on state to a reference voltage line to which a reference voltage is applied; and
a control circuit which receives an instruction signal instructing the light emitting diode to be turned on or off and is configured to control the second transistor to be in an on state when the instruction signal indicates the light on state or to control the second transistor to be in an off state and apply a control voltage having a predetermined voltage value higher than the reference voltage to the source of the first transistor when the instruction signal indicates the light off state.

8. A display device comprising:
a liquid crystal display panel which includes a plurality of scan lines extending in a horizontal direction of a two-dimensional screen and a plurality of data lines extending in a vertical direction of a two-dimensional screen;
a scan driver which sequentially applies horizontal scan pulses to each of the plurality of scan lines;
a data driver which supplies a plurality of drive signals each having a voltage value corresponding to a luminance level of each pixel based on a video signal to the plurality of data lines;
a backlight panel which is installed on a back surface of the liquid crystal display panel and includes first to r-th light emitting diodes connected in series, where r is an integer of 2 or more; and
a light emitting diode driver which drives the first to r-th light emitting diodes,
wherein the light emitting diode driver includes:
an external terminal which is connectable to a cathode of the last light emitting diode among the first to r-th light emitting diodes connected in series;
a first transistor which has its drain connected to the external terminal, receives a drive voltage at its gate, generates an output current corresponding to the drive voltage, and allows the output current to flow between its drain and source;
a second transistor which leads the output current generated by the first transistor in an on state to a reference voltage line to which a reference voltage is applied; and
a control circuit which receives an instruction signal instructing the first to r-th light emitting diodes to be turned on or off and is configured to control the second transistor to be in an on state when the instruction signal indicates the light on state or to control the second transistor to be in an off state and apply a control voltage having a predetermined voltage value higher than the reference voltage to the source of the first transistor when the instruction signal indicates the light off state.

9. The display device according to claim 8,
wherein a back gate of each of the first transistor and the second transistor is connected to the reference voltage line.

10. The display device according to claim 8, further comprising:
a resistor which is included in a current path of the output current including the first transistor and the second transistor and converts the output current into a voltage;
a differential amplifier which receives a voltage signal specifying a current value of the output current by a voltage value and outputs a difference between the voltage signal and the voltage converted by the resistor to the gate of the first transistor as the drive voltage via a first node; and
a third transistor which receives the instruction signal at a gate and is turned on to apply the reference voltage to the first node when the instruction signal indicates the light off state.

11. The display device according to claim 9, further comprising:
a resistor which is included in a current path of the output current including the first transistor and the second transistor and converts the output current into a voltage;
a differential amplifier which receives a voltage signal specifying a current value of the output current by a voltage value and outputs a difference between the voltage signal and the voltage converted by the resistor to the gate of the first transistor as the drive voltage via a first node; and
a third transistor which receives the instruction signal at a gate and is turned on to apply the reference voltage to the first node when the instruction signal indicates the light off state.
